(19) United States
(12) Patent Application Publication
(10) Pub. No.: US 2026/0279385 A1
(43) Pub. Date: Sep. 17, 2026

(54) ARTIFICIAL INTELLIGENCE-BASED DATA PROCESSING METHOD AND APPARATUS, ELECTRONIC DEVICE, COMPUTER PROGRAM PRODUCT, AND COMPUTER-READABLE STORAGE MEDIUM

(71) Applicant: Tencent Technology (Shenzhen) Company Limited, Shenzhen (CN)

(72) Inventor: Peiji YANG, Shenzhen (CN)

(73) Assignee: Tencent Technology (Shenzhen) Company Limited, Shenzhen (CN)

(21) Appl. No.: 19/670,571

(22) Filed: May 7, 2026

Related U.S. Application Data
(63) Continuation of application No. PCT/CN2025/072014, filed on Jan. 13, 2025.

(30) Foreign Application Priority Data
Feb. 2, 2024 (CN) 202410147225.3

(51) Int. Cl. G10L 25/63; G06T 13/20; G06T 13/40; G10L 15/02; G10L 15/06; G10L 15/16; G10L 25/30

(52) U.S. Cl. CPC G10L 25/63; G06T 13/205; G06T 13/40; G10L 15/02; G10L 15/063; G10L 15/16; G10L 25/30

(57) ABSTRACT

The artificial intelligence-based data processing method includes: obtaining speech, and obtaining emotion data corresponding to the speech; performing first speech content feature extraction processing on the speech, to obtain a first speech content feature corresponding to the speech, and performing emotion feature extraction processing on the emotion data, to obtain an emotion feature corresponding to the speech; performing fusion processing on the first speech content feature and the emotion feature, to obtain a fused feature corresponding to the speech; and performing animation parameter mapping processing on the fused feature, to obtain a controller parameter corresponding to the speech, the controller parameter being configured for controlling a virtual object model to present in a target image, and the target image matching content and the emotion data of the speech.

### RELATED APPLICATION

This application is a continuation of and claims the benefit of priority to PCT Application No. PCT/CN2025/072014, filed Jan. 13, 2025, and entitled DATA PROCESSING METHOD AND APPARATUS BASED ON ARTIFICIAL INTELLIGENCE, ELECTRONIC DEVICE, COMPUTER PROGRAM PRODUCT, AND COMPUTER READABLE STORAGE MEDIUM, which is based on and claims priority to Chinese Patent Application No. 202410147225.3, filed on Feb. 2, 2024. The above applications are incorporated herein by reference in their entireties.

### FIELD OF THE TECHNOLOGY

The present disclosure relates to the field of speech processing, and in particular, to an artificial intelligence-based data processing method and apparatus, an electronic device, a computer program product, and a computer-readable storage medium.

### BACKGROUND OF THE APPLICATION

Artificial intelligence (AI) is a comprehensive technology of computer science, which studies design principles and implementation methods of various intelligent machines, to enable the machines to have functions of perception, reasoning, and decision-making. The artificial intelligence technology is a comprehensive discipline and relates to a wide range of fields, for example, several major directions such as a natural language processing technology and machine learning/deep learning. With the development of technologies, the artificial intelligence technology will be applied to more fields and deliver increasingly important value.

In the related technology, to achieve facial expression driving of a virtual object, expression bases corresponding to different phonemes need to be produced in advance, then speech is converted into corresponding phonemes, and different expression bases are combined into a complete animation through complex rules. The related technology can only achieve phoneme-based facial expression driving, and a process of combining the expression bases is complex, resulting in low facial expression driving efficiency and low driving accuracy.

### SUMMARY

Embodiments of the present disclosure provide an artificial intelligence-based data processing method and apparatus, an electronic device, a computer program product, and a computer-readable storage medium, which can improve target image driving efficiency and driving accuracy for a virtual object model.

Technical solutions of the embodiments of the present disclosure are implemented in the following manners.

An embodiment of the present disclosure provides an artificial intelligence-based data processing method. The method is performed by an electronic device. The method includes:
obtaining speech, and obtaining emotion data corresponding to the speech;
performing first speech content feature extraction processing on the speech, to obtain a first speech content feature corresponding to the speech, and performing emotion feature extraction processing on the emotion data, to obtain an emotion feature corresponding to the speech;
performing fusion processing on the first speech content feature and the emotion feature, to obtain a fused feature corresponding to the speech; and
performing animation parameter mapping processing on the fused feature, to obtain a controller parameter corresponding to the speech,
the controller parameter being configured for controlling a virtual object model to present in a target image, and the target image matching content and the emotion data of the speech.

An embodiment of the present disclosure provides an artificial intelligence-based data processing apparatus, including:
an obtaining module, configured to obtain speech, and obtain emotion data corresponding to the speech;
a feature extraction module, configured to perform first speech content feature extraction processing on the speech, to obtain a first speech content feature corresponding to the speech, and perform emotion feature extraction processing on the emotion data, to obtain an emotion feature corresponding to the speech;
a superposition processing module, configured to perform fusion processing on the first speech content feature and the emotion feature, to obtain a fused feature corresponding to the speech; and
a mapping processing module, configured to perform animation parameter mapping processing on the fused feature, to obtain a controller parameter corresponding to the speech, the controller parameter being configured for controlling a virtual object model to present in a target image, and the target image matching content and the emotion data of the speech.

An embodiment of the present disclosure provides an electronic device. The electronic device includes:
a memory, configured to store computer-executable instructions; and
a processor, configured to implement, when executing the computer-executable instructions stored in the memory, the artificial intelligence-based data processing method provided in the embodiments of the present disclosure.

An embodiment of the present disclosure provides a computer-readable storage medium, having computer-executable instructions stored therein, configured to implement, when executed by a processor, the artificial intelligence-based data processing method provided in the embodiments of the present disclosure.

An embodiment of the present disclosure provides a computer program product, including computer-executable instructions, the computer-executable instructions, when executed by a processor, implementing the artificial intelligence-based data processing method provided in the embodiments of the present disclosure.

The embodiments of the present disclosure have following beneficial effects:

Speech is obtained, and emotion data corresponding to the speech is obtained, to obtain content of the speech and an emotion corresponding to the speech. First speech content feature extraction processing is performed on the speech, to obtain a first speech content feature corresponding to the speech for representing the speech, and emotion feature extraction processing is performed on the emotion data, to obtain an emotion feature corresponding to the speech for representing a speech emotion. Fusion processing is performed on the speech content feature and the emotion feature, to obtain a fused feature corresponding to the speech, that is, a speech characteristic and an emotion characteristic can be simultaneously represented, and animation parameter mapping processing is performed on the fused feature, to obtain a controller parameter corresponding to the speech. The controller parameter is configured for controlling a virtual object model to present in a target image, and the target image matches the content of the speech and the emotion data. A mapping process from features to the controller parameter is directly established, thereby directly obtaining the controller parameter for driving the virtual object model to present in the target image, improving driving efficiency while also improving target image driving efficiency of the virtual object model from two dimension of the speech and the emotion.

### BRIEF DESCRIPTION OF THE DRAWINGS

FIG. 1 is an example schematic architectural diagram of a data processing system according to an embodiment of the present disclosure.

FIG. 2 is an example schematic structural diagram of a server according to an embodiment of the present disclosure.

FIG. 3A is an example schematic flowchart of an artificial intelligence-based data processing method according to an embodiment of the present disclosure.

FIG. 3B is an example flowchart of an artificial intelligence-based data processing method according to an embodiment of the present disclosure.

FIG. 4 is an example schematic diagram of a training process of an emotion extraction network according to an embodiment of the present disclosure.

FIG. 5A is an example flowchart of a training process of a parameter-driven model according to an embodiment of the present disclosure.

FIG. 5B is an example flowchart of a training process of a parameter-driven model according to an embodiment of the present disclosure.

FIG. 6 is an example flowchart of a background service of a speech facial driving service according to an embodiment of the present disclosure.

FIG. 7 is an example flowchart of a background service of a virtual human live streaming according to an embodiment of the present disclosure.

FIG. 8 is an example schematic architectural diagram of a parameter-driven model according to an embodiment of the present disclosure.

FIG. 9 is an example schematic diagram of a character facial animation production page according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict.

In the following descriptions, related term “first/second/third” is merely intended to distinguish similar objects but does not necessarily indicate a specific order of an object. “First/Second/Third” is interchangeable in terms of a specific order or sequence if permitted, so that the embodiments of the present disclosure described herein can be implemented in a sequence in addition to the sequence shown or described herein.

In the embodiments of the present disclosure, the term “module” or “unit” refers to a computer program or a part of a computer program with a predetermined function, which works together with other related parts to achieve a predetermined objective, and may be fully or partially implemented using software, hardware (such as a processing circuit or a memory), or a combination thereof. Similarly, one processor (or a plurality of processors or memories) may be configured to realize one or more modules or units. Furthermore, the module or unit may be a part of an integrated module or unit that includes the functionality of the module or unit.

Unless otherwise defined, all technical and scientific terms used in the embodiments of the present disclosure have the same meanings as those commonly understood by a person skilled in the art. Terms used in the embodiments of the present disclosure are only intended to describe the embodiments of the present disclosure, and are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.

(1) Four-dimensional scan (4D Scan): Based on three-dimensional scan, a time axis is added, so that each frame is a scanned three-dimensional model. Four-dimensional scan is between the three-dimensional scan and motion capture. A normal animation production process is three-dimensional scan, model cleaning, skeleton and muscle rigging, and animation production through manual adjustment or motion capture data.

(2) Artificial intelligence generative content (AIGC): It is content automatically created and generated by artificial intelligence, such as images, videos, music, text, and the like. By using comprehension, imagination, and creativity of artificial intelligence, various content is created according to specified requirements and styles, such as articles, short stories, reports, music, images, and even videos.

(3) Wav2vec2 model: It is a pre-training model of automatic speech recognition, and completes a speech recognition task by predicting a speech unit of a masked part of speech. First, a multi-layer convolutional neural network is used to process original waveforms of speech audio. These original waveforms are inputted into a quantizer and a self-attention model (transformer). The quantizer selects a speech unit from a learned unit list as a latent audio representation vector. The self-attention model adds information from an entire audio sequence, and outputs a result for calculating a loss function. The wav2vec2 model needs to identify a correct quantized speech unit through a masked position.

(4) Voice operated character animation (VOCA): A user may input text or speech, and generate a corresponding facial expression coefficient of a virtual object through a rule or a deep learning algorithm, to accurately drive a lip shape and a facial expression of the virtual object, thereby generating a facial animation of the virtual object.

In recent years, related technologies such as virtual human live streaming and generative artificial intelligence are extremely popular, and the related technologies also have many applications in the game production field, for example, speech synthesis, action generation, and three-dimensional facial animation generation. A speech-driven facial solution refers to converting an inputted speech signal into a facial expression and a lip shape related to the speech signal. This technology may be applied to fields such as speech assistants, virtual characters, and games, making human-computer interaction more intelligent and humanized. The lip shape is driven by using the speech, so that a lip shape of a virtual character or an animated character may be synchronized with the speech, enhancing interest and realism of human-computer interaction.

A speech-driven lip shape solution in the related technology is classified into an expert system-based solution and a deep learning-based solution that is popular in recent years. In the expert system-based solution, professional animators are required to produce expression bases corresponding to different phonemes in advance, then speech is converted into corresponding phonemes, and different expression bases are combined into a complete animation through complex rules. In the deep learning-based solution, an audio vector of a speech signal is obtained, the audio vector is inputted into a deep learning model, and three-dimensional vertex coordinate changes of a three-dimensional facial head model are outputted.

When this embodiment of the present disclosure is implemented, the applicant has found that the related technology has the following problems:

(1) The expert system-based solution requires animation experts to formulate detailed mapping rules for phonemes of speech and three-dimensional lip shapes according to actual facial motion rules, which is time-consuming and labor-intensive and is limited by professional levels of the animation experts.

(2) The deep learning method directly maps a signal to vertex cloud of a three-dimensional model. Consequently, when an animator modifies a three-dimensional animation, modification of vertices of the three-dimensional model is required, which is not conducive to secondary modification of the three-dimensional animation. In addition, this method does not perform additional processing on an emotion in speech, resulting in inability to synthesize an expression similar to the emotion of the speech.

The embodiments of the present disclosure provide an artificial intelligence-based data processing method and apparatus, an electronic device, a computer-readable storage medium, and a computer program product, which can improve target image driving efficiency and driving accuracy for a virtual object model.

The artificial intelligence-based data processing method provided in the embodiments of the present disclosure may be independently implemented by a terminal/server, or may be collaboratively implemented by a terminal and a server. For example, the server independently takes the following artificial intelligence-based data processing method. Alternatively, after obtaining speech and emotion data, the terminal sends the speech and the emotion data to the server, and the server performs the artificial intelligence-based data processing method according to the received speech and emotion data.

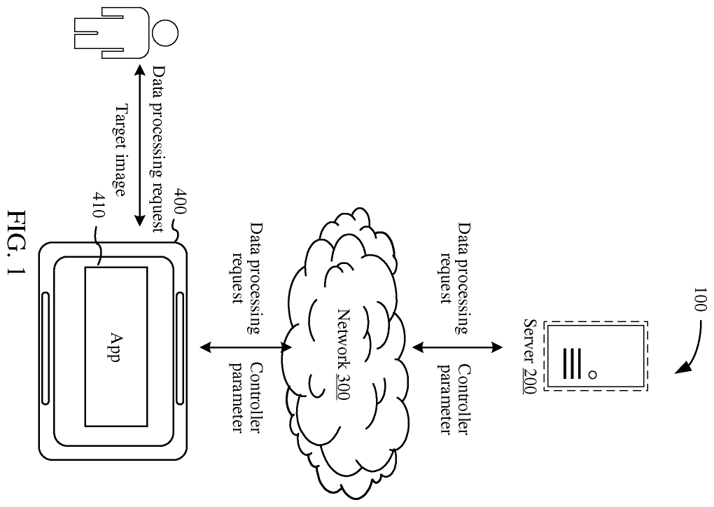

Referring to FIG. 1, FIG. 1 is a schematic architectural diagram of a data processing system 100 according to an embodiment of the present disclosure. To support an artificial intelligence-based data processing application, a terminal 400 is connected to a server 200 through a network 300. The network 300 may be a wide area network, a local area network, or a combination thereof.

In some embodiments, the terminal 400 is configured to generate a data processing request. For example, when a user inputs speech through a graphical interface 410 of the terminal 400, the terminal 400 generates a data processing request corresponding to the speech. The server 200 is configured to obtain the speech according to the data processing request corresponding to the speech, obtain emotion data corresponding to the speech, perform speech content feature extraction processing on the speech to obtain a speech content feature corresponding to the speech, perform emotion feature extraction processing on the emotion data to obtain an emotion feature corresponding to the speech, perform superposition processing on the speech content feature and the emotion feature to obtain a superposed feature corresponding to the speech, and perform animation parameter mapping processing on the superposed feature to obtain a controller parameter corresponding to the speech. The controller parameter is configured for controlling a virtual object model to present in a target image, and the target image matches content and the emotion data of the speech. The server 200 feeds back the controller parameter corresponding to the speech to the terminal 400, and the terminal 400 controls the virtual object model to present in the target image according to the controller parameter corresponding to the speech.

In some embodiments, the terminal 400 is configured to generate a data processing request. For example, when a user inputs speech and emotion data through a graphical interface 410 of the terminal 400, the terminal 400 generates a data processing request carrying the speech and the emotion data, and sends the data processing request to the server 200. The server 200 obtains the speech and the emotion data corresponding to the speech, performs speech content feature extraction processing on the speech, to obtain a speech content feature corresponding to the speech, performs emotion feature extraction processing on the emotion data, to obtain an emotion feature corresponding to the speech, performs superposition processing on the speech content feature and the emotion feature, to obtain a superposed feature corresponding to the speech, and performs animation parameter mapping processing on the superposed feature, to obtain a controller parameter corresponding to the speech. The controller parameter is configured for controlling a virtual object model to present in a target image, and the target image matches content of the speech and the emotion data. The server 200 feeds back the controller parameter corresponding to the speech to the terminal 400, and the terminal 400 controls the virtual object model to present in the target image according to the controller parameter corresponding to the speech.

In some embodiments, the data processing method provided in the embodiments of the present disclosure may be applied to the field of games. For example, at a game development stage, by using the data processing method provided in the embodiments of the present disclosure, speech may be directly inputted to control the virtual object model to present in the target image. Because a presented image of a virtual object in a game changes quickly (for example, a process in which a game character A conceives of his classic lines is a dynamic presented image of the game character A), by using the data processing method provided in the embodiments of the present disclosure, the virtual object model may be controlled to present in different target images at any time with adjustment of the speech, thereby improving iteration efficiency and iteration accuracy of the presented image of the virtual object. For example, the data processing method provided in the embodiments of the present disclosure may further be applied to a user generated content (UGC) scenario in a game. For example, in the UGC scenario, by using the data processing method provided in the embodiments of the present disclosure, speech and emotion data inputted by the user are obtained, and the virtual object model may be automatically controlled to present in a target image. The target image matches content of the speech and the emotion data, so that the user may autonomously customize the target image of the virtual object model, thereby improving human-computer interaction efficiency. For example, the data processing method provided in the embodiments of the present disclosure may further be applied to a user intelligent interaction scenario in a game. For example, in the user intelligent interaction scenario, dialogue speech inputted by the user is obtained, to generate reply speech and emotion data that are configured for replying to the dialogue speech. According to the data processing method provided in the embodiments of the present disclosure, based on the reply speech and the emotion data, a virtual object model of an intelligent non-player character (NPC) in the game may be automatically controlled to present in a target image and the reply speech is simultaneously outputted. The target image matches content and the emotion data of the reply speech, that is, a lip shape of the intelligent non-player character conforms to the content of the reply speech, and a facial expression and an action of the intelligent non-player character match the emotion data, so that a game effect in which the NPC performs intelligent dialogue with the user is formed, thereby effectively enriching a human-computer interaction manner and improving human-computer interaction efficiency.

The data processing method provided in the embodiments of the present disclosure may further be applied to a live streaming scenario. For example, in a news live streaming scenario, a virtual anchor performs live streaming, and a virtual object model of the virtual anchor may be automatically controlled by inputting speech, so that the virtual anchor presents in a target image, thereby implementing anchor image construction with both speech and an emotion, and improving driving accuracy and driving efficiency for the virtual object model in a live streaming process.

An electronic device configured to perform the data processing method provided in the embodiments of the present disclosure may be various types of terminal devices or servers. In some embodiments, the server 200 may be an independent physical server, or may be a server cluster formed by a plurality of physical servers or a distributed system, and may further be a cloud server providing basic cloud computing services such as a cloud service, a cloud database, cloud computing, a cloud function, cloud storage, a network service, cloud communication, a middleware service, a domain name service, a security service, a content delivery network (CDN), a big data and artificial intelligence platform. The terminal 400 may be, but is not limited to, a smartphone, a tablet computer, a notebook computer, a desktop computer, a smart speaker, a smartwatch, a smart voice interaction device, a smart appliance, an in-vehicle terminal, an aircraft, or the like. The terminal and the server may be connected directly or indirectly in a wired or wireless communication manner. This is not limited in the embodiments of the present disclosure.

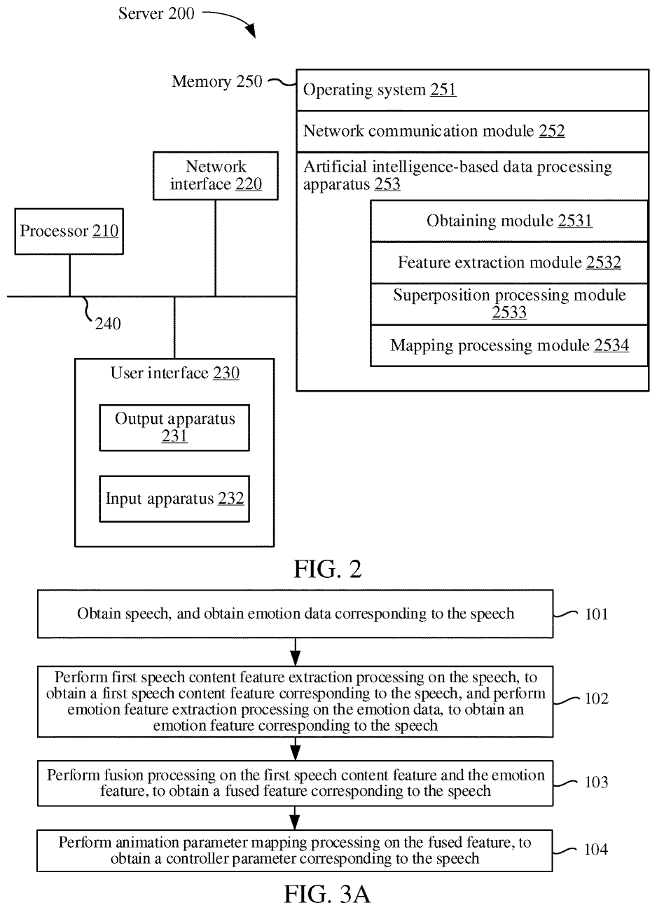

Referring to FIG. 2, FIG. 2 is a schematic structural diagram of the server 200 according to an embodiment of the present disclosure. The server 200 shown in FIG. 2 includes: at least one processor 210, a memory 250, at least one network interface 220, and a user interface 230. Various components in the server 200 are coupled together by using a bus system 240. The bus system 240 is configured to implement connection communication between the components. In addition to a data bus, the bus system 240 further includes a power bus, a control bus, and a status signal bus. However, for ease of clear description, all types of buses in FIG. 2 are marked as the bus system 240.

The processor 210 may be an integrated circuit chip with signal processing capabilities, such as a general-purpose processor, a digital signal processor (DSP), or other programmable logic devices, discrete gates, transistor logic devices, or discrete hardware components. The general-purpose processor may be a microprocessor, any conventional processor, or the like.

The user interface 230 includes one or more output apparatuses 231 that facilitate the presentation of media content, including one or more speakers and/or one or more visual displays. The user interface 230 further includes one or more input apparatuses 232, including user interface components that help user input, for example, a keyboard, a mouse, a microphone, a touchscreen display screen, a camera, and other input buttons and controls.

The memory 250 is removable, non-removable, or a combination thereof. For example, a hardware device includes a solid-state memory, a hard disk drive, or an optical disk drive. In an embodiment, the memory 250 includes one or more storage devices physically located away from the processor 210.

The memory 250 includes a volatile memory or a non-volatile memory, and may include both a volatile memory and a non-volatile memory. The non-volatile memory may be a read only memory (ROM), and the volatile memory may be a random access memory (RAM). The memory 250 described in this embodiment of the present disclosure is intended to include any suitable type of memories.

In some embodiments, the memory 250 can store data to support various operations. An example of the data includes a program, a module, a data structure, or a subset or superset thereof. Example descriptions are provided below.

An operating system 251 includes a system program for processing various basic system services and executing a hardware-related task, for example, a framework layer, a core library layer, and a driver layer, and is configured to implement various basic services and process a hardware-based task.

A network communication module 252 is configured to connect to other electronic devices via one or more (wired or wireless) network interfaces 220. The exemplary network interfaces 220 include Bluetooth, WiFi, universal serial bus (USB), and the like.

In some embodiments, the apparatus provided in the embodiments of the present disclosure may be implemented by software. FIG. 2 shows an artificial intelligence-based data processing apparatus 253 stored in the memory 250, which may be software in a form of a program and a plug-in, and includes software modules such as an obtaining module 2531, a feature extraction module 2532, a superposition processing module 2533, and a mapping processing module 2534. The modules are logical and may be combined in different manners or further split based on to-be-implemented functions. Functions of the modules are described in the following specification.

In some embodiments, the terminal or the server may implement the artificial intelligence-based data processing method provided in the embodiments of the present disclosure by running various computer-executable instructions or a computer program. For example, the computer-executable instructions may be microprogram-level commands, machine instructions, or software instructions. The computer program may be a native program or a software module in an operating system, may be a native application (APP), namely, a program that needs to be installed in an operating system to run, such as a game APP, or may be a mini program that may be embedded in any APP, namely, a program that only needs to be downloaded into a browser environment to run. In conclusion, the foregoing computer-executable instructions may be instructions in any form, and the foregoing computer program may be an application, a module, or a plug-in in any form.

The artificial intelligence-based data processing method provided by the embodiment of the present disclosure will be described with reference to the exemplary application and implementation of the server provided by the embodiments of the present disclosure. As described above, the electronic device implementing the artificial intelligence-based data processing method of the embodiments of the present disclosure may be a terminal, a server, or a combination thereof. Therefore, an execution body of each operation is not repeatedly described below.

In the following example of the artificial intelligence-based data processing method, a facial animation is used as an example for description. A person skilled in the art may apply, according to understanding of the following, the artificial intelligence-based data processing method provided in this embodiment of the present disclosure to animation processing including another type of objects.

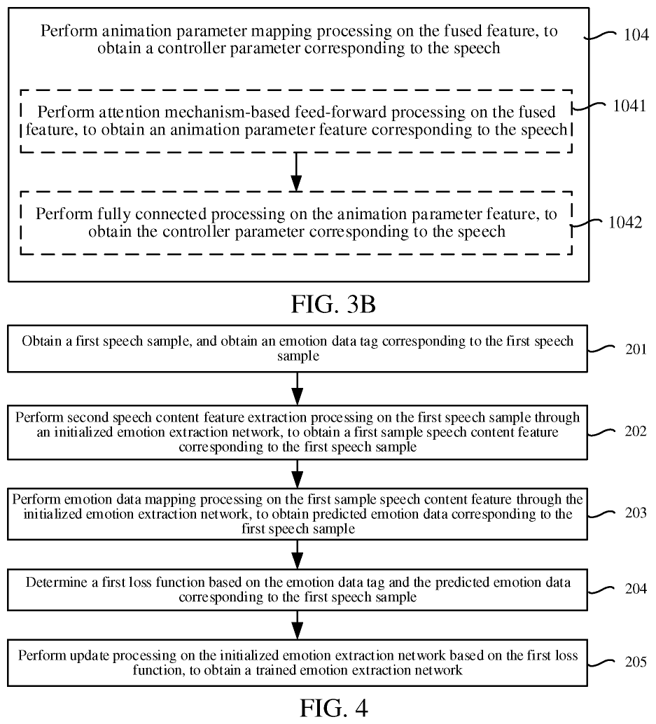

Referring to FIG. 3A, FIG. 3A is a schematic flowchart of an artificial intelligence-based data processing method according to an embodiment of the present disclosure. Description is provided with reference to operation 101 to operation 104 shown in FIG. 3A.

Operation 101: Obtain speech, and obtain emotion data corresponding to the speech.

As an example, the speech may be an audio file including speech, or may be a segment of real-time speech. In an application scenario of virtual object image animation production, the speech is usually speech obtained through processing by a front-end module. The front-end module may be a processing module capable of implementing text-to-speech conversion, or may be another processing module whose output is speech. The emotion data corresponding to the speech is a matrix representing various emotions expressed by content of the speech.

As an example, the emotion data may be an emotion intensity matrix. The emotion intensity matrix is a one-dimensional matrix, each position corresponds to a different emotion type, and a value at each position represents an emotion intensity of a corresponding emotion type. For example, the emotion intensity matrix is [1, 0, 0, 0, 0, 0, 0]. The first position represents joy, the second position represents anger, the third position represents sadness, the fourth position represents surprise, the fifth position represents fear, the sixth position represents disgust, and the seventh position represents no emotion. It is equivalent to that there is only the emotion of joy, and an intensity is 1. A higher intensity value represents a stronger emotion of this type.

In some embodiments, the obtaining emotion data corresponding to the speech in operation 101 may be implemented in the following manner: performing any one of the following processing: obtaining emotion data inputted by an object; and performing second speech content feature extraction processing on the speech, to obtain a second speech content feature corresponding to the speech, and performing emotion data mapping processing on the second speech content feature, to obtain the emotion data corresponding to the speech.

As an example, the emotion data corresponding to the speech may be the emotion data inputted by the object. For example, the user customizes the emotion data corresponding to the speech according to an emotion corresponding to the content of the speech. Alternatively, the emotion data may be emotion data obtained by performing emotion extraction on the speech, or may be emotion data obtained by adjusting, by the user, the emotion data obtained by performing emotion extraction on the speech as a basis. A specific manner is selected according to an actual requirement. This is not limited in the present disclosure.

As an example, when the emotion data is obtained by performing emotion extraction on the speech, first, second speech content feature extraction processing is performed on the speech through a second speech content feature extraction network in an emotion extraction network, to obtain the second speech content feature corresponding to the speech, and then emotion data mapping processing is performed on the second speech content feature through an emotion identification network in the emotion extraction network, to obtain the emotion data corresponding to the speech. The second speech content feature extraction network may be a wav2vec2 model, or may be another model capable of being configured to extract a speech content feature. For example, for speech A1 “How did I get here?”, according to formula (1), second speech content feature extraction processing is performed on the speech A1 through the wav2vec2 model, to obtain a second speech content feature H_{A1} corresponding to the speech A1:

$${H}_{A 1} = w a v 2 v e c 2 ( A 1 ) \qquad ( 1 )$$

H_{A1} is an output of the wav2vec2 model. Then, emotion data mapping is performed on the second speech content feature H_{A1} through the emotion identification network, to obtain emotion data e_{A1} corresponding to the speech A1. The emotion data e_{A1}ϵ{joy, anger, sadness, surprise, fear, disgust}, and the emotion data e_{A1}={e_{joy}, e_{anger}, e_{sadness}, eₛᵤᵣₚᵣᵢₛₑ, e_{fear}, e_{disgust}} corresponding to the speech A1={0, 0, 0, 0.8, 0.2, 0}, where e_{joy} is an emotion intensity corresponding to the emotion “joy”, e_{anger} is an emotion intensity corresponding to the emotion “anger”, e_{sadness} is an emotion intensity corresponding to the emotion “sadness”, eₛᵤᵣₚᵣᵢₛₑ is an emotion intensity corresponding to the emotion “surprise”, e_{fear} is an emotion intensity corresponding to the emotion “fear”, and e disgust is an emotion intensity corresponding to the emotion “disgust”.

As an example, wav2vec2 is a self-supervised pre-training model, and is configured for a speech recognition task. Wav2vec2 does not require annotated speech data for training, and uses an unannotated speech library for pre-training. This enables the model to be applicable to languages that lack annotated data. Wav2vec2 employs a contrastive learning strategy. This method learns useful representations by comparing speech segments from different time periods, to predict a future segment of audio content. During model training, various augmentations are performed on original audio, such as time stretching and noise addition, which helps the model learn more robust and general speech representations. Wav2vec2 uses autoregressive prediction to predict a next token in an audio sequence at a pre-training stage. This enables the model to learn a long-distance dependency relationship in the audio sequence. The model captures details and structures in audio by using time context of different scales, and processes the details and the structures through different convolutional layers. After pre-training is completed, the model may be fine-tuned on a particular downstream task through a small amount of annotated data, to further improve performance.

By obtaining the emotion data corresponding to the speech through user-defined or speech emotion extraction, the emotion data corresponding to the speech may be obtained manually or automatically according to an actual requirement. In addition, the emotion represented by the emotion data can conform to user expectations, so that the controller parameter obtained based on the emotion data and the speech can meet the actual requirement, thereby enabling a finally generated facial animation to match the speech and the speech emotion.

In some embodiments, the performing emotion data mapping processing on the second speech content feature, to obtain the emotion data corresponding to the speech in operation 101 may be implemented in the following manner: performing fully connected processing on the second speech content feature, to obtain a first linear mapping result; and performing maximum likelihood processing on the first linear mapping result, to obtain the emotion data corresponding to the speech.

As an example, emotion data mapping processing is performed on the second speech content feature H_{A1} through the emotion identification network. The emotion identification network is formed by a fully connected layer and a normalization layer. According to formula (2), the second speech content feature H_{A1} is mapped to emotion data e_{A1} corresponding to the speech A1 through the fully connected layer and the normalization layer:

$${e}_{A 1} = softmax ( linear ( {H}_{A 1} ) ) \qquad ( 2 )$$

linear(H_{A1}) is a first linear mapping result obtained by the fully connected layer performing fully connected processing on the second speech content feature H_{A1}, and softmax(linear(H_{A1})) is an output result obtained by the normalization layer (softmax layer) performing maximum likelihood processing on the first linear mapping result linear(H_{A1}), that is, the emotion data e_{A1} corresponding to the speech A1.

By performing fully connected processing and maximum likelihood processing on the second speech content feature, the emotion data corresponding to the speech is obtained, so that the emotion data configured for predicting a controller parameter can be outputted as a prediction result, thereby ensuring that predicted emotion data can be adjusted according to an actual requirement, and further enabling the controller parameter obtained based on the emotion data and the speech to meet the actual requirement. In this way, the finally generated facial animation matches the speech and the speech emotion.

Operation 102: Perform first speech content feature extraction processing on the speech, to obtain a first speech content feature corresponding to the speech, and perform emotion feature extraction processing on the emotion data, to obtain an emotion feature corresponding to the speech.

As an example, first speech content feature extraction processing is performed on the speech A1 through the first speech content feature extraction network in the parameter-driven model. The first speech content feature extraction network may be the wav2vec2 model, or may be another model capable of extracting the content feature of the speech. Using an example in which the first speech content feature extraction network is a wav2vec2 model, first speech content feature extraction processing is performed on the speech A1 through formula (3), to obtain a first speech content feature H_{c} corresponding to the speech A1:

$${H}_{c} = \{ wav 2 vec 2 ( A 1 ) \} \qquad ( 3 )$$

wav2vec2(A1) is an output obtained by the wav2vec2 model performing first speech content feature extraction processing on the speech A1.

As an example, through the emotion feature extraction network in a parameter-driven model, emotion feature extraction processing is performed on the emotion data e_{A1} corresponding to the speech A1 according to formula (4), to obtain an emotion feature Hₑ corresponding to the speech:

$${H}_{e} = {\sum }_{i = 1}^{q} E M B ( {e}_{i} ) \qquad ( 4 )$$

eᵢ is an i^{th} dimension of emotion data in q dimensions of emotion data of the emotion data e_{A1}, EMB(eᵢ) is an emotion feature extraction result corresponding to eᵢ of the emotion feature extraction network, and the emotion feature Hₑ is obtained by fusing q emotion feature extraction results.

Operation 103: Perform fusion processing on the first speech content feature and the emotion feature, to obtain a fused feature corresponding to the speech.

As an example, fusion processing is performed on the first speech content feature H_{c} and the emotion feature Hₑ corresponding to the speech A1, to obtain a fused feature H_{c}+Hₑ corresponding to the speech A1. Fusion processing may be superposition processing, splicing processing, or other processing methods capable of fusing different features. This is not limited in the present disclosure.

Operation 104: Perform animation parameter mapping processing on the fused feature, to obtain a controller parameter corresponding to the speech.

As an example, the controller parameter is configured for controlling a virtual object model to present in a target image, and the target image matches the content and the emotion data of the speech.

As an example, the target image includes, but is not limited to, a facial image, a body image, and the like.

As an example, matching the emotion data means matching the target image with the emotion intensity corresponding to each emotion type represented by the emotion data. For example, if the intensities corresponding to anger and sadness in the emotion data are 0.5 and 0.7 respectively, and the intensities corresponding to other emotion types are 0, the target image may represent moderate anger and strong sadness. Matching the speech may have two situations: a lip shape of the target image may matching the speech, that is, the target image appears to be broadcasting the speech; or the target image as a whole may match an instruction meaning represented by the speech, that is, the target image is an action or an expression in response to the speech, for example, if the speech is “raise hands”, the target image may present an action of raising hands.

As an example, in the fields of virtual reality (VR), augmented reality (AR), and digital human, the controller parameter is used to ensure that presentation of a virtual object or a virtual character matches an input (such as the content of the speech and the emotion data) of the user, thereby creating more natural and immersive user experience. The controller parameter refers to a series of variables or settings, and may be used to operate and control a presentation manner of the virtual object or the model. These parameters may include: a position parameter, which controls a position of the object in a virtual space; a rotation parameter, which controls a direction or an orientation of the object; a scaling parameter, which controls a size of the object; a form parameter, which controls details such as a shape or a facial expression of the object; a texture parameter, which controls a surface texture and color of the object; and an animation parameter, which controls movement and an animation of the object.

As an example, the target image refers to an appearance and a state that a virtual object or a character is to present, and is determined based on the following factors: the content of the speech, where the virtual character needs to adjust a representation of the virtual character according to the content of the speech of the user, for example, if the user says “I am very happy”, the lip shape of the virtual character matches “I am very happy”; and the emotion data, where by analyzing the speech or other biological features (such as a heart rate and a skin conductance) of the user, an emotion state of the user may be inferred, an emotion representation of the virtual character is further adjusted, and the virtual character may present a smiling expression to achieve emotion synchronization.

According to this embodiment of the present disclosure, the virtual object is rendered in a virtual environment by using the adjusted controller parameter, so that the virtual object is presented in the target image. This may be applied to the following scenarios: a virtual assistant scenario: when responding to a query of the user, a virtual assistant presents a body language and an expression that match answer content; a virtual social scenario: in a virtual social environment, the virtual character of the user may present a corresponding representation according to an emotion and speech of the user; and a game character scenario: a character in a game may present a corresponding response according to a behavior and an emotion of a player. Quality of user experience may be greatly improved by accurately controlling a presentation of the virtual object, so that interaction is more natural and real.

Referring to FIG. 3B, FIG. 3B is a flowchart of an artificial intelligence-based data processing method according to an embodiment of the present disclosure. In some embodiments, operation 104 shown in FIG. 3A may be implemented by using operation 1041 and operation 1042 shown in FIG. 3B, and details are described below.

Operation 1041: Perform attention mechanism-based feed-forward processing on the fused feature, to obtain an animation parameter feature corresponding to the speech.

In some embodiments, operation 1041 may be implemented in the following manner: performing, through an n^{th} feed-forward network among the N cascaded feed-forward networks, attention mechanism-based mapping processing on an input of the n^{th} feed-forward network, to obtain an n^{th} mapping result, and transmitting the n^{th} mapping result outputted by the n^{th} feed-forward network to an (n+1)^{th} feed-forward network to continue performing attention mechanism-based mapping processing, to obtain an (n+1)^{th} mapping result corresponding to the (n+1)^{th} feed-forward network; and using an N^{th} mapping result outputted by an N^{th} feed-forward network as the animation parameter feature corresponding to the speech.

As an example, attention mechanism-based feed-forward processing is implemented through an attention feed-forward network, and the attention feed-forward network includes N cascaded feed-forward networks, N being an integer greater than 1. n is an integer variable incrementing from 1, n is not less than 1 and less than N, when n is 1, the input of the n^{th} feed-forward network is the fused feature, and when n is not less than 2 and less than N, the input of the n^{th} feed-forward network is an (n−1)^{th} mapping result outputted by an (n−1)^{th} feed-forward network.

As an example, for a first feed-forward network, attention mechanism-based feed-forward processing is performed on an input of the first feed-forward network (for the first feed-forward network, the input is the fused feature H_{c}+Hₑ corresponding to the speech A1), to obtain a first feed-forward result, and the first feed-forward result outputted by the first feed-forward network is transmitted to a second feed-forward network to continue performing attention mechanism-based mapping processing, thereby obtaining a second feed-forward result corresponding to the second feed-forward network. The rest can be deduced by analogy. An N^{th} mapping result outputted by an N^{th} feed-forward network is used as an animation parameter feature corresponding to the speech A1. The feed-forward network may be a feed-forward transformer (FFT) network.

By using the N cascaded attention feed-forward networks, attention mechanism-based feed-forward processing is performed on the fused feature for a plurality of times, to obtain the animation parameter feature corresponding to the speech, so that speech information and emotion information included in the animation parameter feature are richer and more accurate, thereby enabling the controller parameter obtained according to the emotion data and the speech to meet an actual requirement. In this way, a finally generated facial animation matches the speech and the speech emotion.

In some embodiments, when n is not less than 2 and less than N, the performing attention mechanism-based mapping processing on an input of the n^{th} feed-forward network, to obtain an n^{th} mapping result may be implemented in the following manners: performing attention processing on the (n−1)^{th} mapping result, to obtain an n^{th} attention feature; performing addition processing on the (n−1)^{th} mapping result and the n^{th} attention feature, to obtain an n^{th} intermediate feature; performing convolution processing on the n^{th} intermediate feature, to obtain an n^{th} convolutional feature; and performing addition processing on the n^{th} convolutional feature and the n^{th} intermediate feature, to obtain the n^{th} mapping result.

As an example, for the first feed-forward network, attention processing is performed on the fused feature H_{c}+Hₑ, to obtain a first attention feature, and addition processing is performed on the fused feature H_{c}+Hₑ and the first attention feature, to obtain a first intermediate feature; convolution processing is performed on the first intermediate feature, to obtain a first convolutional feature; addition processing is performed on the first convolutional feature and the first intermediate feature, to obtain the first feed-forward result; the first feed-forward result is inputted into the second feed-forward network, where the second feed-forward network performs the following processing: performing attention processing on the first feed-forward result, to obtain a second attention feature; performing addition processing on the first feed-forward result and the second attention feature, to obtain a second intermediate feature; and performing convolution processing on the second intermediate feature, to obtain a second convolutional feature; and addition processing is performed on the second convolutional feature and the second intermediate feature, to obtain the second feed-forward result.

In the feed-forward network, after attention processing is performed, residual processing is performed on the (n−1)^{th} mapping result and the n^{th} attention feature, and after convolution processing is performed, residual processing is performed on the n^{th} intermediate feature and the n^{th} convolutional feature, thereby avoiding a gradient disappearance problem, improving an expression capability of the feed-forward network, making the speech information and the emotion information included in the finally obtained animation parameter feature more accurate, and further enabling the controller parameter obtained according to the emotion data and the speech to meet an actual requirement, so that the finally generated facial animation matches the speech and the speech emotion.

In some embodiments, when n is not less than 2 and less than N, the performing attention processing on the (n−1)^{th} mapping result, to obtain an n^{th} attention feature may be implemented in the following manners: obtaining a query matrix, a key matrix, and a value matrix of each attention network; performing the following processing through each attention network: performing single-head attention processing on the (n−1)^{th} mapping result based on the query matrix, the key matrix, and the value matrix of the attention network, to obtain a single-head attention result corresponding to the attention network; and performing fusion processing on single-head attention results respectively corresponding to the plurality of attention networks, to obtain the n^{th} attention feature.

In some embodiments, the n^{th} feed-forward network includes a plurality of attention networks. For each attention network, a query weight matrix, a key weight matrix, and a value weight matrix of the attention matrix are obtained, and the query weight matrix, the key weight matrix, and the value weight matrix are multiplied with the (n−1)^{th} mapping result respectively, to obtain the query matrix, the key matrix, and the value matrix of the attention network. First, a dot product of the query matrix and the key matrix is calculated, then the dot product of the query matrix and the key matrix is divided by a square root of a dimension of a key vector in the key matrix, to obtain a similarity score matrix, normalization processing is performed on the similarity score matrix, to obtain a normalized matrix, and matrix multiplication processing is performed on the normalized matrix and the value matrix, to obtain the single-head attention result corresponding to the attention network. Fusion processing is performed on the single-head attention results respectively corresponding to the plurality of attention networks in the n^{th} feed-forward network, to obtain the n^{th} attention feature of the n^{th} feed-forward network.

By providing the plurality of attention networks in the feed-forward network, performing multi-head attention processing on the feed-forward result, calculating a plurality of attention matrices, and fusing attention results corresponding to the plurality of attention networks, accuracy of the attention feature is improved, so that the speech information and the emotion information included in the finally obtained animation parameter feature are more accurate, thereby enabling the controller parameter obtained according to the emotion data and the speech to meet an actual requirement. In this way, the finally generated facial animation matches the speech and the speech emotion.

An attention score is calculated by comparing the query matrix and the key matrix. This is usually performed in a manner such as a dot product or an addition model. Normalization processing is performed on the calculated attention score, to generate an attention distribution. This is generally implemented through a softmax function. A final output is generated based on the attention distribution and the value matrix, where the output is a weighted sum of the input and the attention distribution, thereby improving a feature expression capability of the attention feature.

Operation 1042: Perform fully connected processing on the animation parameter feature, to obtain the controller parameter corresponding to the speech.

As an example, the controller parameter is configured for controlling a virtual object model to present in the target image, and the target image matches the content and the emotion data of the speech. Through a fully connected layer of the parameter-driven model, fully connected processing is performed on the animation parameter feature corresponding to the speech A1 according to formula (5), to obtain a controller parameter Ŷ corresponding to the speech A1:

$$\hat{Y} = Linear ( {H}_{a m} ) \qquad ( 5 )$$

Hₐₘ is the animation parameter feature corresponding to the speech A1, and Linear (Hₐₘ) is an output result obtained by the fully connected layer performing fully connected processing on the animation parameter feature Hₐₘ.

By performing multi-head self-attention feed-forward processing on the fused feature, the animation parameter feature including accurate information of the corresponding content of the speech and the speech emotion is obtained, and then the animation parameter feature is mapped to the controller parameter corresponding to the speech, so that the facial expression of the virtual object model is directly adjusted according to the controller parameter without adjusting vertices of the virtual object model, thereby generating a facial animation corresponding to the speech and the emotion data. In addition, this facilitates an operation of animation production personnel and improves efficiency of facial animation production.

In some embodiments, based on a time sequence of a plurality of speech frames in the speech, the plurality of speech frames are divided into a plurality of speech frame sequences.

As an example, the speech includes a plurality of speech frames, the emotion data includes a plurality of emotion intensity sub-matrices, the controller parameter includes a plurality of parameter combinations, each speech frame sequence is in one-to-one correspondence with each emotion intensity sub-matrix, and each speech frame sequence is in one-to-one correspondence with each control parameter. For example, for the speech being A={a¹, . . . , a^{T}}, where T is a quantity of samples of audio, taking 16 kHz audio as an example, a quantity of speech frames of 1s speech is 16000, a^{x} (x=1, . . . , T) is a speech signal of an x^{th} sampling point, and a real controller parameter corresponding to the speech A is Y={y¹, . . . , y^{M}}, Mis a quantity of animation frames, generally 50 frames per second, and yⁱ (i=1, . . . , M) is a real controller parameter corresponding to an i^{th} animation frame. It can be seen that the speech frame and the real control parameter are not in a one-to-one correspondence relationship. Because the quantity of speech frames is greater than the quantity of animation frames, the speech frames need to be divided according to the time sequence, the speech frames are divided into speech frame sequences corresponding to the animation frames, and each speech frame sequence has a corresponding emotion strength sub-matrix configured to represent an emotion strength. In this way, a problem of predicting the controller parameter according to the speech and the emotion data corresponding to the speech may be refined into a problem of predicting a real control parameter of a corresponding animation frame according to each speech frame sequence and an emotion strength sub-matrix corresponding to each speech frame sequence.

The plurality of speech frames of the speech are divided into the speech frame sequences corresponding to the animation frames, and the real control parameter of the corresponding animation frame is predicted according to each speech frame sequence and the emotion intensity sub-matrix corresponding to each speech frame sequence, so that each animation frame can reflect the content of the speech and the speech emotion included in the speech frame sequence, and the generated facial animation of a virtual object image is more detailed and smoother, thereby improving an expression effect of the facial animation.

In some embodiments, a plurality of emotion intensity values corresponding to each speech frame sequence are obtained; matrix processing is performed on the plurality of emotion intensity values, to obtain the emotion intensity sub-matrix corresponding to each speech frame sequence; and the plurality of emotion intensity sub-matrices corresponding to the plurality of speech frame sequences are combined as the emotion data.

As an example, each emotion intensity sub-matrix includes a plurality of emotion intensity values of a plurality of emotions corresponding to each speech frame sequence, for example, if each emotion intensity sub-matrix represents six emotions of joy, anger, sadness, surprise, fear, and disgust, it has six emotion intensity values e_{joy}, e_{anger}, e_{sadness}, eₛᵤᵣₚᵣᵢₛₑ, e_{fear}, and e_{disgust} corresponding to these six emotions, and matrix processing is performed on the six emotion intensity values according to a specific rule, to obtain the emotion intensity sub-matrix e_{sub}={e_{joy}, e_{anger}, e_{sadness}, eₛᵤᵣₚᵣᵢₛₑ, e_{fear}, e_{disgust}}, and then the plurality of emotion intensity sub-matrices are combined according to a time sequence relationship between the speech frame sequence corresponding to the emotion intensity sub-matrix, to obtain the emotion data corresponding to the speech.

The emotion intensity sub-matrix is represented by using the emotion intensity values corresponding to different emotions, so that complex emotions can be combined and represented in a matrix form, and the emotion represented by the emotion intensity sub-matrix corresponding to the speech frame sequence is richer and more accurate. In addition, the emotion intensity is represented in the matrix form, which is easy to understand, and facilitates adjustment of the emotion data according to an actual requirement. Further, the controller parameter obtained according to the emotion data and the speech can meet an actual requirement, so that the finally generated facial animation matches the speech and the speech emotion.

Referring to FIG. 4, FIG. 4 is a schematic diagram of a training process of an emotion extraction network according to an embodiment of the present disclosure. In some embodiments, before executing operation 101, operation 201 to operation 205 shown in FIG. 4 may further be executed, and details are described below.

Operation 201: Obtain a first speech sample, and obtain an emotion data tag corresponding to the first speech sample.

As an example, the first speech sample may be an audio file including the content of the speech, and the emotion data tag corresponding to the first speech sample is configured for representing an emotion corresponding to the first speech sample. For example, for a first speech sample A2 “I don't like eating apples”, an expressed emotion is disgust, therefore an emotion data tag corresponding to the first speech sample A2 is e_{A2}={e_{joy}, e_{anger}, e_{sadness}, eₛᵤᵣₚᵣᵢₛₑ, e_{fear}, e disgust}={0, 0, 0, 0, 0, 1}. The emotion data tag e_{A2} represents an emotion intensity corresponding to only one emotion, that is, an emotion intensity of the disgust emotion (e_{disgust}=1, the emotion intensities corresponding to other emotions are 0). During actual use, the emotion data tag e_{A2} may also represent emotion intensities corresponding to a plurality of emotions. This is not limited in the present disclosure.

Operation 202: Perform second speech content feature extraction processing on the first speech sample through an initialized emotion extraction network, to obtain a first sample speech content feature corresponding to the first speech sample.

As an example, second speech content feature extraction processing is performed on the first speech sample A2 through a second speech content feature extraction network in the initialized emotion extraction network, to obtain a first sample speech content feature H_{A2} corresponding to the first speech sample A2. An implementation of this operation is the same as that of operation 101. Details are not described herein again.

Operation 203: Perform emotion data mapping processing on the first sample speech content feature through the initialized emotion extraction network, to obtain predicted emotion data corresponding to the first speech sample.

As an example, emotion data mapping processing is performed on the first sample speech content feature H_{A2} through an emotion identification network in the initialized emotion extraction network, to obtain predicted emotion data P corresponding to the first speech sample A2 according to formula (6):

$$P = soft max ( linear ( {H}_{A 2} ) ) \qquad ( 6 )$$

linear(H_{A2}) is a second linear mapping result obtained by the fully connected layer performing fully connected processing on the first sample speech content feature H_{A2}, and softmax(linear(H_{A2})) is an output result obtained by the normalization layer (softmax layer) performing maximum likelihood processing on the second linear mapping result linear(H_{A2}), that is, the predicted emotion data P corresponding to the first speech sample A2.

Operation 204: Determine a first loss function based on the emotion data tag and the predicted emotion data corresponding to the first speech sample.

As an example, according to formula (7), a first loss function e_{A2} is determined based on the emotion data tag P and the predicted emotion data L′ corresponding to the first speech sample A2:

$${L}^{′} = CE ( {e}_{A 2} , P ) \qquad ( 7 )$$

CE(e_{A2}, P) is a cross-entropy loss function calculated based on the emotion data tag e_{A2} and the predicted emotion data P, and the first loss function may alternatively be a loss function of another type. This is not limited in the present disclosure.

Operation 205: Perform update processing on the initialized emotion extraction network based on the first loss function, to obtain the trained emotion extraction network.

As an example, based on the first loss function L′, update processing is performed on the initialized emotion extraction network, to obtain a trained emotion extraction network, and the trained emotion extraction network may perform second speech content feature extraction processing on the speech, to obtain the second speech content feature corresponding to the speech, and perform emotion data mapping processing on the second speech content feature, to obtain the emotion data corresponding to the speech in operation 101. A network structure of the emotion extraction network is not limited in the embodiments of the present disclosure, that is, another network structure may alternatively be used.

By using the first speech sample, update processing is performed on the initialized emotion extraction network, so that the trained emotion extraction network can automatically extract the corresponding emotion data from the speech, for generating the facial animation of the virtual object image matching the speech and the emotion.

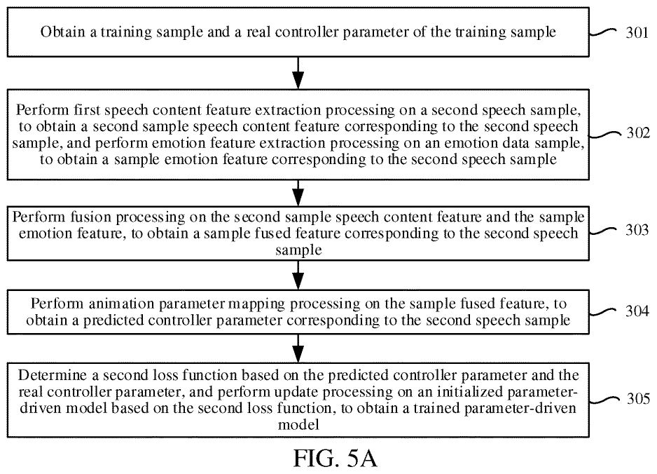

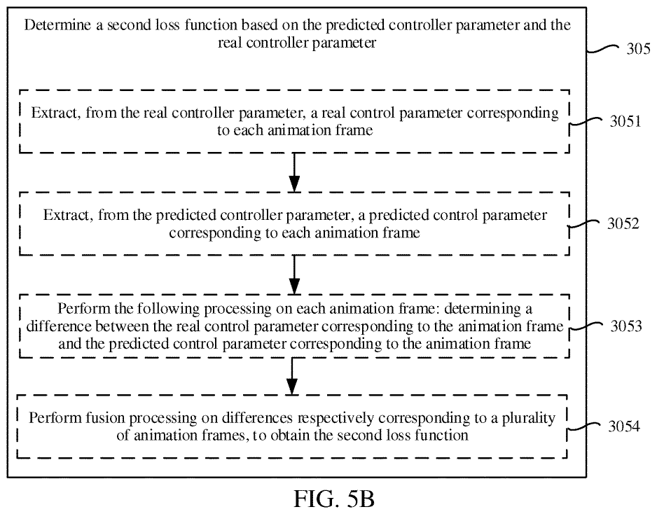

Referring to FIG. 5A, FIG. 5A is a flowchart of a training process of a parameter-driven model according to an embodiment of the present disclosure. In some embodiments, before executing operation 101, operation 301 to operation 305 shown in FIG. 5A may further be executed, and details are described below.

Operation 301: Obtain a training sample and a real controller parameter of the training sample.

As an example, the training sample includes a second speech sample and an emotion data sample corresponding to the second speech sample. As an example, a second speech sample A3 may be an audio file including the content of the speech, and an emotion data sample corresponding to the second speech sample A3 is configured for representing an emotion corresponding to the second speech sample A3. For example, for the second speech sample A3 “I don't like eating apples”, an expressed emotion is disgust, therefore the emotion data sample corresponding to the second speech sample A3 is e_{A3}= {e_{joy}, e_{anger}, e_{sadness}, eₛᵤᵣₚᵣᵢₛₑ, e_{fear}, e_{disgust}}={0, 0, 0, 0, 0, 1}. The emotion data sample e_{A3} represents an emotion intensity corresponding to only one emotion, that is, an emotion intensity of the disgust emotion (e_{disgust}=1, the emotion intensities corresponding to other emotions are 0). During actual use, the emotion data sample e_{A3} may also represent emotion intensities corresponding to a plurality of emotions. This is not limited in the present disclosure. A real controller parameter corresponding to the second speech sample A3 and the emotion data sample e_{A3} is a standard controller parameter capable of reflecting the content of the speech and the emotion of the second speech sample A3.

The following processing is performed through an initialized parameter-driven model:

Operation 302: Perform first speech content feature extraction processing on the second speech sample, to obtain a second sample speech content feature corresponding to the second speech sample, and perform emotion feature extraction processing on the emotion data sample, to obtain a sample emotion feature corresponding to the second speech sample.

As an example, first speech content feature extraction processing is performed on the second speech sample A3 through the first speech content feature extraction network in the initialized parameter-driven model. The first speech content feature extraction network may be the wav2vec2 model, or may be another model capable of extracting the content feature of the speech. Using an example in which the first speech content feature extraction network is a wav2vec2 model, first speech content feature extraction processing is performed on the second speech sample A3 through formula (8), to obtain a second sample speech content feature H_{c}′ corresponding to the second speech sample A3:

$${H}_{c}^{′} = \{ wav 2 vec 2 ( A 3 ) \} \qquad ( 8 )$$

wav2vec2(A3) is an output obtained by the wav2vec2 model performing first speech content feature extraction processing on the second speech sample A3.

As an example, through the emotion feature extraction network in the initialized parameter-driven model, emotion feature extraction processing is performed on the emotion data sample e_{A3} corresponding to the second speech sample A3 according to formula (9), to obtain a sample emotion feature Hₑ′ corresponding to the second speech sample A3:

$${H}_{e}^{′} = {\sum }_{i = 1}^{q} EMB ( {e}_{i} ) \qquad ( 9 )$$

eᵢ is an i^{th} dimension of emotion data in q dimensions of emotion data of the emotion data sample e_{A3}, EMB(eᵢ) is an emotion feature extraction result corresponding to et of the emotion feature extraction network, and the sample emotion feature Hₑ′ is obtained by fusing q emotion feature extraction results.

Operation 303: Perform fusion processing on the second sample speech content feature and the sample emotion feature, to obtain a sample fused feature corresponding to the second speech sample.

As an example, fusion processing is performed on the second sample speech content feature H_{c}′ and the sample emotion feature Hₑ′ corresponding to the second speech sample A3, to obtain a sample fused feature H_{c}′+Hₑ′ corresponding to the second speech sample A3. Fusion processing may be superposition processing, splicing processing, or other processing methods capable of fusing different features. This is not limited in the present disclosure.

Operation 304: Perform animation parameter mapping processing on the sample fused feature, to obtain a predicted controller parameter corresponding to the second speech sample.

As an example, attention mechanism-based feed-forward processing is performed on the sample fused feature H_{c}′+Hₑ′, to obtain an animation parameter feature corresponding to the second speech sample A3, and fully connected processing is performed on the animation parameter feature, to obtain a predicted controller parameter corresponding to the second speech sample A3.

Operation 305: Determine a second loss function based on the predicted controller parameter and the real controller parameter, and perform update processing on the initialized parameter-driven model based on the second loss function, to obtain the trained parameter-driven model.

Referring to 5B, FIG. 5B is a flowchart of a training process of a parameter-driven model according to an embodiment of the present disclosure. In some embodiments, the determining a second loss function based on the predicted controller parameter and the real controller parameter in operation 305 of FIG. 5A may be implemented through operation 3051 to operation 3054 shown in FIG. 5B, and details are described below.

Operation 3051: Extract, from the real controller parameter, a real control parameter corresponding to each animation frame.

As an example, the real controller parameter is Y={y¹, . . . , y^{M}}, where M is a quantity of animation frames, and yⁱ is the real control parameter corresponding to the i^{th} animation frame in the real controller parameter.

Operation 3052: Extract, from the predicted controller parameter, a predicted control parameter corresponding to each animation frame.

As an example, the predicted controller parameter is Ŷ={ŷ¹, . . . , ŷ^{M}}, where M is the quantity of animation frames, and ŷⁱ is the predicted control parameter corresponding to the i^{th} animation frame in the predicted controller parameter.

Operation 3053: Perform the following processing on each animation frame: determining a difference between the real control parameter corresponding to the animation frame and the predicted control parameter corresponding to the animation frame.

As an example, a difference between the real control parameter yⁱ and the predicted control parameter ŷⁱ of the i^{th} animation frame is calculated to be yⁱ-ŷⁱ, and the rest can be deduced by analogy, to obtain a plurality of differences between the real control parameters and the predicted control parameters of a plurality of animation frames.

As an example, the difference may be an L1 norm difference, or may be an L2 norm difference, where the L1 norm difference is an absolute value, and the L2 norm difference is a sum of squares of differences of control parameters of respective types.

Operation 3054: Perform fusion processing on differences respectively corresponding to a plurality of animation frames, to obtain the second loss function.

As an example, fusion processing may be directly performed on the differences, to obtain the second loss function, or fusion processing may be performed on squares of the differences, to obtain the second loss function.

As an example, fusion processing is performed on a plurality of differences between the real control parameters and the predicted control parameters of the plurality of animation frames, to obtain a second loss function L″. Since Y={y¹, . . . , y^{M}} and Ŷ={ŷ¹, . . . , ŷ^{M}}, fusion processing is performed on the differences=yⁱ−ŷⁱ corresponding to the plurality of animation frames, which may be expressed by formula (10):

$${L}^{″} = {‖ Y - \hat{Y} ‖}^{2} \qquad ( 10 )$$

Y is the real controller parameter corresponding to the second speech sample A3, and Ŷ is the predicted controller parameter corresponding to the second speech sample A3. Update processing is performed on the initialized parameter-driven model based on the second loss function L″, to obtain the trained parameter-driven model.

The second loss function is calculated based on the difference between the real control parameter and the predicted control parameter of each animation frame, to perform update training on the initialized parameter-driven model. This is equivalent to training the initialized parameter-driven model by using a plurality of sub-samples at a time, to improve training efficiency and accuracy of the parameter-driven model, to ensure that the controller parameter predicted by the parameter-driven model according to the speech and the emotion data matches the speech and the emotion data, and further generate the facial animation of the virtual object image matching the speech and the emotion data.

The initialized parameter-driven model is trained by using the second speech sample, and the second loss function is determined according to the predicted controller parameter and the real controller parameter, to update the initialized parameter-driven model, to obtain the parameter-driven model, to ensure that the controller parameter obtained by the parameter-driven model through prediction according to the speech and the emotion data matches the speech and the emotion data, thereby generating the facial animation of the virtual object image matching the speech and the emotion data.

An exemplary application of this embodiment of the present disclosure to an actual virtual person live streaming application scenario is described below.

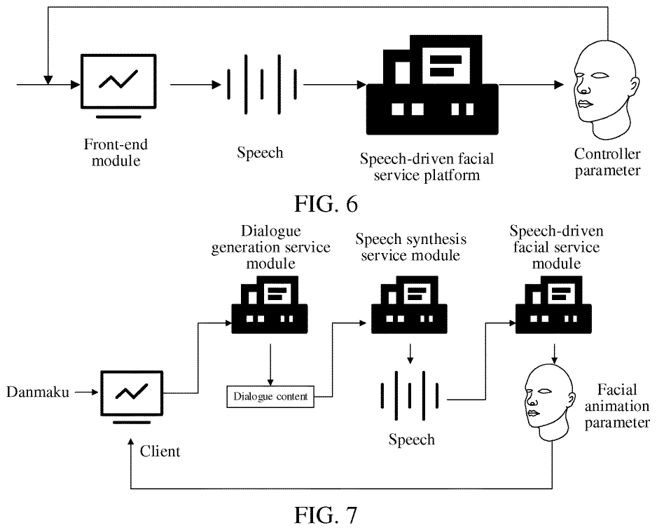

Referring to FIG. 6, FIG. 6 is a flowchart of a background service of a speech facial driving service according to an embodiment of the present disclosure. As shown in FIG. 6, a front-end module generates speech according to an input, and a speech-driven facial service platform performs controller parameter prediction processing on the speech by invoking a parameter-driven model provided in this embodiment of the present disclosure, to obtain a controller parameter corresponding to a virtual object model. A type of the front-end module is determined according to an actual requirement, for example, in the following application scenario of virtual human live streaming, the front-end module may be a module integrating a dialogue generation service module and a speech synthesis service module, and in the following application scenario of facial animation production, the front-end module may alternatively be a speech file input module. The type of the front-end module is selected according to a type of an upstream task, provided that an output is speech. This is not limited in the present disclosure.

Referring to FIG. 7, FIG. 7 is a flowchart of a background service of a virtual human live streaming according to an embodiment of the present disclosure. As shown in FIG. 7, in a scenario of virtual human live streaming, a danmaku in the live broadcast scenario is grabbed, dialogue content responding to the danmaku is generated through the dialogue generation service module, the dialogue content is converted into speech through the speech synthesis service module, a facial animation parameter corresponding to the speech, that is, a controller parameter, is generated through a speech-driven facial service module, finally a virtual human is driven to make a corresponding facial animation according to the facial animation parameter, and the virtual human interacts with the danmaku on a client in coordination with the speech. The speech-driven facial service module includes a parameter-driven model provided in this embodiment of the present disclosure.

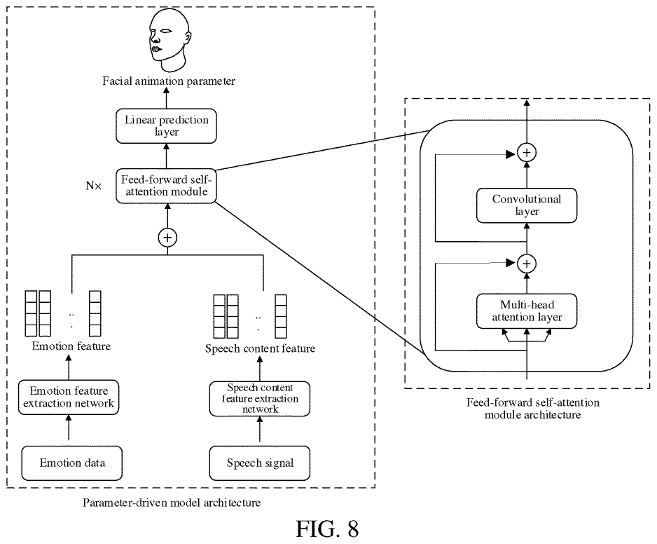

Referring to 8, FIG. 8 is a schematic architectural diagram of a parameter-driven model according to an embodiment of the present disclosure. As shown in FIG. 8, an input of the parameter-driven model is a speech signal and emotion data, and one speech signal corresponds to one piece of emotion data. For example, for a speech signal a1, corresponding emotion data is [0.1, 0.2, 0.3, 0.4, 0.1, 0.05], and the emotion data is one-dimensional. An output of the parameter-driven model is a facial animation parameter corresponding to a binding animation-driven system, and specifically a controller parameter. The input emotion data may be manually specified by the user, or may be directly extracted from the speech by using an emotion identification module. For the input speech signal, the speech content feature is first extracted from the speech signal through the speech content feature extraction network. Then, the emotion data is converted into the emotion feature through the emotion feature extraction network. The speech content feature and the emotion feature are superimposed, to obtain a superimposed feature. The superimposed feature is inputted into a multilayer neural network model. The multilayer neural network model includes N cascaded feed-forward transformer (FFT) modules. The multilayer neural network model performs feed-forward self-attention processing on the superimposed feature, and finally regresses a feed-forward self-attention processing result through a linear prediction layer, to obtain a final facial animation parameter, that is, a controller parameter. An animation-driven system drives faces of a plurality of virtual human characters according to the controller parameter, thereby implementing a driving effect of a plurality of different characters. An operation process of the parameter-driven model is described in detail below.

The parameter-driven model mainly includes two parts: a first speech content feature extraction network and an emotion feature extraction network. During model training, an emotion data sample inputted into the emotion feature extraction network is manually annotated based on the speech and animation data. At a training stage, each second speech sample has only one emotion with an intensity of 1, that is, only one emotion of [joy, anger, sadness, surprise, fear, disgust, none] is manually annotated for the speech. If joy is annotated, corresponding emotion data sample is [1, 0, 0, 0, 0, 0, 0]. The rest can be deduced by analogy. Assuming that a speech signal corresponding to the second speech sample is A= {a¹, . . . , a^{T}}, where T is a quantity of sample points of audio, taking 16 kHz audio as an example, a quantity of sample points of 1s audio is 16000, a^{x} (x=1, . . . , T) is a speech signal of an x^{th} sampling point, and a real controller parameter corresponding to the speech signal A is Y={y¹, . . . , y^{M}}, Mis a quantity of animation frames, generally 50 frames per second, and yⁱ (i=1, . . . , M) is a real controller parameter corresponding to an i^{th} animation frame. The speech signal corresponding to the second speech sample is inputted into the first speech content feature extraction network (the first speech content feature extraction network may be a wav2vec2 model, or may be another model configured to extract the speech content feature), and a second sample speech content feature H_{c} is obtained through formula (11):

$${H}_{c} = \{ wav 2 vec 2 ( A ) \} \qquad ( 11 )$$

$${H}_{c} = \{ {h}_{c}^{1} , ... , {h}_{c}^{M} \} , {h}_{c}^{i} ( i = 1 , ... , M )$$

is a second sample speech content feature corresponding to the i^{th} animation frame, and wav2vec2(A) is an output obtained by the wav2vec2 model processing the speech signal A={a¹, . . . , a^{T}}. After the second sample speech content feature is obtained, the emotion data sample e manually annotated needs to be inputted into the emotion feature extraction network. eϵ{joy, anger, sadness, surprise, fear, disgust} corresponds to 6 emotions, and the sample emotion feature Hₑ is obtained through formula (12), where the emotion feature extraction network has only the fully connected layer, and an output of the emotion feature extraction network is a sample emotion feature Hₑ:

$${H}_{e} = {\sum }_{i = 1}^{6} EMB ( {e}_{i} ) \qquad ( 12 )$$

eᵢ is an i^{th} dimension of emotion data in 6 dimensions of emotion data of the emotion data sample e, EMB(eᵢ) is an emotion feature extraction result corresponding to et of the emotion feature extraction network, and the sample emotion feature Hₑ is obtained by fusing 6 emotion feature extraction results.

Since there is only one non-zero value in the manually annotated emotion data sample e, at the training stage, formula (12) may be written as formula (13):

$${H}_{e} = EMB ( e ) \qquad ( 13 )$$

EMB(e) is the output of the emotion feature extraction network with the emotion data sample e as the input.

Then, the second sample speech content feature and the sample emotion feature are fused, where fusion may be addition or concatenation, to obtain a sample fused feature Hₑ+H_{c}, and the sample fused feature Hₑ+H_{c} is inputted into the multi-layer feed-forward transformer (FFT) module, to obtain a sample animation feature. Finally, through the fully connected layer, the sample animation feature is mapped to a predicted controller parameter Ŷ according to formula (14):

$$\hat{Y} = Linear ( FFT ( {H}_{e} + {H}_{c} ) ) \qquad ( 14 )$$

FFT is the output of the FFT module, and Linear is the output of the fully connected layer. With continued reference to FIG. 8, an architecture of the feed-forward transformer (FFT) module is shown on a right side of FIG. 8. Each FFT module mainly includes a multi-head attention layer and a convolutional layer. Multi-head attention processing is first performed on an original input of the FFT module through the multi-head attention layer. After an intermediate result is obtained, residual processing is performed on the original input and the intermediate result, to obtain an intermediate input. Convolution processing is performed on the intermediate input through the convolutional layer, to obtain a convolutional result. Residual processing is performed on the convolutional result and the intermediate input, thereby obtaining a final output of the FFT module.

After the predicted controller parameter Ŷ is obtained, a loss function L1 is calculated through formula (15), and the parameter-driven model is trained according to the second loss function L1:

$$L 1 = {‖ Y - \hat{Y} ‖}^{2} \qquad ( 15 )$$

Y is a real controller parameter corresponding to the speech signal A, and Ŷ is a predicted controller parameter corresponding to the speech signal A. By updating the parameter of the parameter-driven model, a parameter-driven model whose input is an emotion label (that is, the emotion data) and the speech signal and whose output is the controller parameter is finally obtained.

During the foregoing training, the used emotion data sample is manually annotated, while during application, it is sometimes impossible to provide the emotion data corresponding to the speech through manual annotation. In this case, the emotion data corresponding to the speech may be obtained by automatically performing emotion extraction on the speech using the emotion extraction network. Details are described below.

The emotion extraction network configured to automatically extract a speech emotion needs to be constructed. The emotion extraction network includes the wav2vec2 module configured to extract a speech content feature as a second speech content feature extraction network (this part may alternatively be another model that may be configured to extract a speech content feature), a fully connected layer, and a normalization layer (softmax layer). During training of the emotion extraction network, a parallel data pair (A, e) of the first speech sample and the emotion data tag needs to be first constructed, where A is the first speech sample, e is the emotion data tag corresponding to the first speech sample, and eϵ{joy, anger, sadness, surprise, fear, disgust}. The speech A is inputted into the wav2vec2 model of the emotion extraction network, and a first sample speech content feature Hₐ is obtained according to formula (16):

$${H}_{a} = wav 2 vec 2 ( A ) \qquad ( 16 )$$

wav2vec2 is the output of the wav2vec2 model.

Then, the first sample speech content feature Hₐ is inputted into the fully connected layer and the normalization layer (softmax layer), and distribution probabilities of six types of emotions are obtained according to formula (17), that is, predicted emotion data P:

$$P = soft max ( linear ( {H}_{a} ) ) \qquad ( 17 )$$

linear(Hₐ) is a second linear mapping result obtained by the fully connected layer performing fully connected processing on the first sample speech content feature Hₐ, and softmax(linear(Hₐ)) is an output result obtained by performing maximum likelihood processing on the second linear mapping result linear(Hₐ), that is, the predicted emotion data P corresponding to the first speech sample, and P={p_{joy}, p_{anger}, p_{sadness}, pₛᵤᵣₚᵣᵢₛₑ>p_{fear}, p_{disgust}}.

Finally, a cross-entropy loss function L2 (that is, the first loss function) is calculated through formula (18), to train the emotion extraction network, thereby achieving network optimization:

$$L 2 = CE ( e , P ) \qquad ( 18 )$$

e is the emotion data tag eϵ{joy, anger, sadness, surprise, fear, disgust} corresponding to the first speech sample, P is the predicted emotion data corresponding to the first speech sample, P={p_{joy}, p_{anger}, p_{sadness}, pₛᵤᵣₚᵣᵢₛₑ, p_{fear}, p_{disgust}}, and CE(e, P) is the cross-entropy loss function calculated based on the emotion data tag e and the predicted emotion data P.

The final predicted emotion data P may be used as the emotion data inputted into the parameter-driven model at an application end.

During actual application, a piece of speech and emotion data corresponding to the speech may be directly inputted into the parameter-driven model. The emotion data may be emotion data extracted by using the emotion extraction network, or may be emotion data obtained after the user performs user-defined adjustment on a result obtained by extraction by using the emotion extraction network, or may be emotion data customized by the user. Table 1 is an example table of emotion data.

TABLE 1
Example table of emotion data

| | | |
|---|---|---|
| e₁ | joy | 0.5 |
| e₂ | anger | 0.1 |
| e₃ | sadness | 0.2 |
| e₄ | surprise | 0.0 |
| e₅ | fear | 0.15 |
| e₆ | disgust | 0.05 |

Emotion feature extraction processing is performed on the emotion data through the emotion feature extraction network, and an emotion feature Hₑ corresponding to the emotion data is obtained according to formula (19):

$${H}_{e} = {\sum }_{i = 1}^{6} EMB ( {e}_{i} ) \qquad ( 19 )$$

eᵢ is an i^{th} dimension of emotion data in 6 dimensions of emotion data of the emotion data, EMB(eᵢ) is an emotion feature extraction result corresponding to eᵢ of the emotion feature extraction network, and the emotion feature Hₑ is obtained by fusing 6 emotion feature extraction results.

In this way, the first speech content feature and the emotion feature corresponding to the speech are obtained. After fusion processing is performed on the first speech content feature and the emotion feature, the first speech content feature and the emotion feature are inputted into the multi-layer FFT module for feed-forward self-attention processing, and mapping is performed through a fully connected layer, to finally obtain the controller parameter corresponding to the speech.

An exemplary application of this embodiment of the present disclosure to an actual facial animation production application scenario is described below.

After the speech and the corresponding emotion data are obtained, the parameter-driven model is invoked to perform controller parameter prediction processing on the speech and the corresponding emotion data, to obtain the controller parameter corresponding to the speech. The animation-driven system adjusts the controller parameter of the virtual object facial model according to the controller parameter, and controls the virtual object model to present in the target image, to obtain the target facial expression matching the speech and the emotion data.

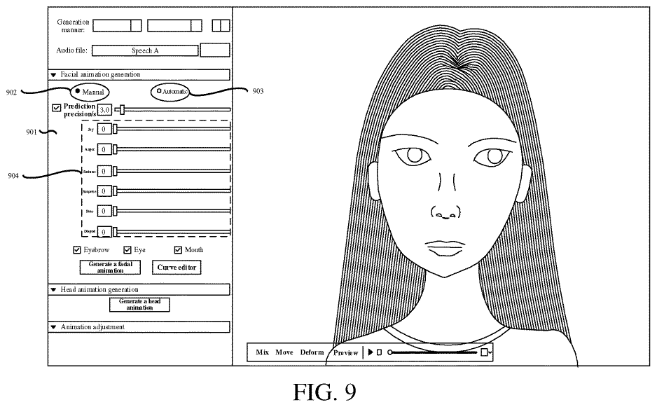

Referring to FIG. 9, FIG. 9 is a schematic diagram of a character animation production page according to an embodiment of the present disclosure. As shown in FIG. 9, speech A is sent to a server by uploading an audio file, an emotion extraction network and a parameter-driven model deployed in the server process the speech A, to obtain a controller parameter corresponding to the speech A, and feed back the controller parameter to a terminal. Controllers corresponding to different emotions are displayed on a character animation production page of the terminal, including six controllers respectively corresponding to joy, anger, sadness, surprise, fear, and disgust, which correspond to six emotions of joy, anger, sadness, surprise, fear, and disgust in the emotion data. The six controllers are respectively adjusted according to the controller parameter corresponding to the speech. In this way, the character animation is adjusted. Specifically, the terminal receives a user upload operation for the speech A, to obtain the speech A, and displays the audio file as the speech A in an interaction interface 901 in the character animation production page. An animation generation panel of the interaction interface 901 includes a manual mode control 902 and an automatic mode control 903. In response to a selection operation on the manual mode control 902, the manual mode control 902 is in a selected state, and an emotion controller 904 in the facial animation generation panel enters an editable state. In this case, the user may perform a sliding operation on a progress bar of an emotion controller of any emotion. For example, in response to sliding operations on progress bars of six emotion controllers respectively corresponding to six emotions of joy, anger, sadness, surprise, fear, and disgust, six pieces of emotion intensity data respectively corresponding to the six emotions of joy, anger, sadness, surprise, fear, and disgust are displayed, and the emotion data corresponding to the speech A is formed by the six pieces of emotion intensity data. The terminal obtains and sends the speech A and the emotion data to the server. The server invokes the parameter-driven model to perform parameter prediction processing on the speech A and the emotion data, to obtain the controller parameter corresponding to the speech A and the emotion data. The terminal drives the character facial model to present the target image corresponding to the speech A and the emotion data according to the controller parameter (in this case, the target image is the target facial expression and the lip shape of the character facial model), and presents the target image of the character facial model in a display area of the interaction interface 901. In response to a selection operation on the automatic mode control 903, the automatic mode control 903 is in the selected state. The terminal sends the speech A to the server. The server invokes the emotion extraction network to perform emotion extraction processing on the speech A, to obtain the emotion data corresponding to the speech A. The server invokes the parameter-driven model to perform parameter prediction processing on the speech A and the emotion data, to obtain the controller parameter corresponding to the speech A and the emotion data. The terminal drives the character facial model to present the target image corresponding to the speech A and the emotion data according to the controller parameter, and displays the target image in the display area of the interaction interface 901, and generates a facial animation of the character facial model in response to a trigger operation on a generated facial animation control, that is, a head animation of the character facial model may further be generated. When the facial animation is generated, the controller parameter includes a control parameter of an expression and a lip shape of the character facial model. When the head animation of the character facial model is generated, the controller parameter further includes a control parameter corresponding to a head motion of the character facial model, for example, a head motion such as nodding, head shaking, or head hanking. In addition, the target image of the character facial model is presented in the display area of the interaction interface 901, and the head animation is generated in response to a trigger operation on the head animation generation control.

In this embodiment of the present disclosure, a driving effect is smoother. In addition, a solution of outputting a controller parameter is used, so that user experience of a developer can be effectively improved. Through automatic emotion extraction of speech, different emotion animations can be automatically adapted according to input speech.

The following continues to describe an exemplary structure, implemented as a software module, of the artificial intelligence-based data processing apparatus 253 provided in this embodiment of the present disclosure. In some embodiments, as shown in FIG. 2, the software module in the artificial intelligence-based data processing apparatus 253 stored in the memory 250 may include: an obtaining module 2531, configured to obtain speech, and obtain emotion data corresponding to the speech; a feature extraction module 2532, configured to perform first speech content feature extraction processing on the speech, to obtain a first speech content feature corresponding to the speech, and perform emotion feature extraction processing on the emotion data, to obtain an emotion feature corresponding to the speech; a superposition processing module 2533, configured to perform fusion processing on the first speech content feature and the emotion feature, to obtain a fused feature corresponding to the speech; and a mapping processing module 2534, configured to perform animation parameter mapping processing on the fused feature, to obtain a controller parameter corresponding to the speech, the controller parameter being configured for controlling a virtual object model to present in a target image, and the target image matching content and the emotion data of the speech.

In some embodiments, the obtaining module 2531 is further configured to perform any one of the following processing: obtaining emotion data inputted by an object; and performing second speech content feature extraction processing on the speech, to obtain a second speech content feature corresponding to the speech, and performing emotion data mapping processing on the second speech content feature, to obtain the emotion data corresponding to the speech.

In some embodiments, the obtaining module 2531 is further configured to obtain a first speech sample, and obtain an emotion data tag corresponding to the first speech sample; perform second speech content feature extraction processing on the first speech sample through an initialized emotion extraction network, to obtain a first sample speech content feature corresponding to the first speech sample; perform emotion data mapping processing on the first sample speech content feature through the initialized emotion extraction network, to obtain predicted emotion data corresponding to the first speech sample; determine a first loss function based on the emotion data tag and the predicted emotion data corresponding to the first speech sample; and perform update processing on the initialized emotion extraction network based on the first loss function, to obtain the trained emotion extraction network.

In some embodiments, the obtaining module 2531 is further configured to perform fully connected processing on the second speech content feature, to obtain a first linear mapping result; and perform maximum likelihood processing on the first linear mapping result, to obtain the emotion data corresponding to the speech.

In some embodiments, the feature extraction module 2532 is further configured to obtain a training sample and a real controller parameter of the training sample, the training sample including a second speech sample and an emotion data sample corresponding to the second speech sample; and perform the following processing through an initialized parameter-driven model: perform first speech content feature extraction processing on the second speech sample, to obtain a second sample speech content feature corresponding to the second speech sample, and perform emotion feature extraction processing on the emotion data sample, to obtain a sample emotion feature corresponding to the second speech sample; perform fusion processing on the second sample speech content feature and the sample emotion feature, to obtain a sample fused feature corresponding to the second speech sample; perform animation parameter mapping processing on the sample fused feature, to obtain a predicted controller parameter corresponding to the second speech sample; and determine a second loss function based on the predicted controller parameter and the real controller parameter, and perform update processing on the initialized parameter-driven model based on the second loss function, to obtain the trained parameter-driven model.

In some embodiments, the feature extraction module 2532 is further configured to extract, from the real controller parameter, a real control parameter corresponding to each animation frame; extract, from the predicted controller parameter, a predicted control parameter corresponding to each animation frame; perform the following processing on each animation frame: determining a difference between the real control parameter corresponding to the animation frame and the predicted control parameter corresponding to the animation frame; and perform fusion processing on differences respectively corresponding to a plurality of animation frames, to obtain the second loss function.

In some embodiments, the mapping processing module 2534 is configured to perform attention mechanism-based feed-forward processing on the fused feature, to obtain an animation parameter feature corresponding to the speech; and perform fully connected processing on the animation parameter feature, to obtain the controller parameter corresponding to the speech.

In some embodiments, the mapping processing module 2534 is further configured to perform, through an n^{th} feed-forward network among the N cascaded feed-forward networks, attention mechanism-based mapping processing on an input of the n^{th} feed-forward network, to obtain an n^{th} mapping result, and transmit the n^{th} mapping result outputted by the n^{th} feed-forward network to an (n+1)^{th} feed-forward network to continue performing attention mechanism-based mapping processing, to obtain an (n+1)^{th} mapping result corresponding to the (n+1)^{th} feed-forward network; and use an N^{th} mapping result outputted by an N^{th} feed-forward network as the animation parameter feature corresponding to the speech, where n is an integer variable incrementing from 1, n is not less than 1 and less than N, when n is 1, the input of the n^{th} feed-forward network is the fused feature, and when n is not less than 2 and less than N, the input of the n^{th} feed-forward network is an (n−1)^{th} mapping result outputted by an (n−1)^{th} feed-forward network. Attention mechanism-based feed-forward processing is implemented through an attention feed-forward network, and the attention feed-forward network includes N cascaded feed-forward networks, N being an integer greater than 1.

In some embodiments, when n is not less than 2 and less than N, the mapping processing module 2534 is further configured to perform attention processing on the (n−1)^{th} mapping result, to obtain an n^{th} attention feature; perform addition processing on the (n−1)^{th} mapping result and the n^{th} attention feature, to obtain an n^{th} intermediate feature; perform convolution processing on the n^{th} intermediate feature, to obtain an n^{th} convolutional feature; and perform addition processing on the n^{th} convolutional feature and the n^{th} intermediate feature, to obtain the n^{th} mapping result.

In some embodiments, the mapping processing module 2534 is further configured to obtain a query matrix, a key matrix, and a value matrix of each attention network; perform the following processing through each attention network: performing single-head attention processing on the (n−1)^{th} mapping result based on the query matrix, the key matrix, and the value matrix of the attention network, to obtain a single-head attention result corresponding to the attention network; and perform fusion processing on single-head attention results respectively corresponding to the plurality of attention networks, to obtain the n^{th} attention feature, the n^{th} feed-forward network including a plurality of attention networks.

An embodiment of the present disclosure provides a computer program product. The computer program product includes computer-executable instructions. The computer-executable instructions are stored in a computer-readable storage medium. A processor of an electronic device reads the computer-executable instructions from the computer-readable storage medium, and executes the computer-executable instructions, to cause the electronic device to perform the artificial intelligence-based data processing method provided in the embodiments of the present disclosure.

An embodiment of the present disclosure provides a computer-readable storage medium, having computer-executable instructions stored therein, the computer-executable instructions, when executed by a processor, causing the processor to perform the artificial intelligence-based data processing method, for example, the artificial intelligence-based data processing method shown in FIG. 3A, provided in the embodiments of the present disclosure.

In some embodiments, the computer-readable storage medium may be a memory such as a RAM, a ROM, a flash memory, a magnetic surface memory, an optical disc, or a CD-ROM; or may be any device including one or any combination of the foregoing memories.

In some embodiments, the computer-executable instructions may be written in a form of a program, software, a software module, a script, or code according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may, but do not necessarily correspond to, a file in a file system, and may be stored as a part of a file having another program or data stored therein. For example, the computer-executable instructions are stored in one or more scripts in a hypertext markup language (HTML) text, stored in a single file dedicated to a discussed program, or stored in a plurality of collaborative files (for example, files having one or more modules, subprograms, or code parts).

For example, the computer-executable instructions may be deployed to be executed on one electronic device, or on a plurality of electronic devices located at one location, or on a plurality of electronic devices distributed at a plurality of locations and interconnected through a communication network.

In conclusion, speech is obtained, and emotion data corresponding to the speech is obtained, to obtain content of the speech and an emotion corresponding to the speech. First speech content feature extraction processing is performed on the speech, to obtain a first speech content feature corresponding to the speech for representing the speech, and emotion feature extraction processing is performed on the emotion data, to obtain an emotion feature corresponding to the speech for representing a speech emotion. Fusion processing is performed on the speech content feature and the emotion feature, to obtain a fused feature corresponding to the speech, that is, a speech characteristic and an emotion characteristic can be simultaneously represented, and animation parameter mapping processing is performed on the fused feature, to obtain a controller parameter corresponding to the speech. The controller parameter is configured for controlling a virtual object model to present in a target image, and the target image matches the content of the speech and the emotion data. A mapping process from features to the controller parameter is directly established, thereby directly obtaining the controller parameter for driving the virtual object model to present in the target image, improving driving efficiency while also improving target image driving efficiency of the virtual object model from two dimension of the speech and the emotion.

The foregoing descriptions are merely embodiments of the present disclosure, and are not intended to limit the scope of protection of the present disclosure. Any modification, equivalent replacement, and improvement made within the spirit and scope of the present disclosure are included in the protection scope of the present disclosure.

What is claimed is:

1. An artificial intelligence-based data processing method, performed by an electronic device, and comprising:
obtaining a speech and emotion data corresponding to the speech;
performing a first speech content feature extraction processing on the speech, to obtain a first speech content feature corresponding to the speech, and performing an emotion feature extraction processing on the emotion data, to obtain an emotion feature corresponding to the speech;
performing a fusion processing on the first speech content feature and the emotion feature, to obtain a fused feature corresponding to the speech; and
performing an animation parameter mapping processing on the fused feature, to obtain a controller parameter corresponding to the speech, the controller parameter being configured for controlling a virtual object model to present in a target image, wherein the target image matches content and the emotion data of the speech.

2. The method according to claim 1, wherein obtaining the emotion data corresponding to the speech comprises:
performing any one of following processing:
obtaining the emotion data inputted by an object; and
performing a second speech content feature extraction processing on the speech, to obtain a second speech content feature corresponding to the speech, and performing an emotion data mapping processing on the second speech content feature, to obtain the emotion data corresponding to the speech.

3. The method according to claim 2, wherein performing the emotion data mapping processing on the second speech content feature, to obtain the emotion data corresponding to the speech comprises:
performing a fully connected processing on the second speech content feature, to obtain a first linear mapping result; and
performing a maximum likelihood processing on the first linear mapping result, to obtain the emotion data corresponding to the speech.

4. The method according to claim 3, wherein the emotion data is obtained by invoking a trained emotion extraction network; and the method further comprises:
obtaining a first speech sample, and obtaining an emotion data tag corresponding to the first speech sample;
performing the second speech content feature extraction processing on the first speech sample through an initialized emotion extraction network, to obtain a first sample speech content feature corresponding to the first speech sample;
performing the emotion data mapping processing on the first sample speech content feature through the initialized emotion extraction network, to obtain predicted emotion data corresponding to the first speech sample;
determining a first loss function based on the emotion data tag and the predicted emotion data corresponding to the first speech sample; and
performing an update processing on the initialized emotion extraction network based on the first loss function, to obtain the trained emotion extraction network.

5. The method according to claim 4, wherein the controller parameter is obtained by invoking a trained parameter-driven model; and the method further comprises:
obtaining a training sample and a real controller parameter of the training sample, the training sample comprising a second speech sample and an emotion data sample corresponding to the second speech sample; and
performing following processing through an initialized parameter-driven model:
performing the first speech content feature extraction processing on the second speech sample, to obtain a second sample speech content feature corresponding to the second speech sample, and performing the emotion feature extraction processing on the emotion data sample, to obtain a sample emotion feature corresponding to the second speech sample;
performing the fusion processing on the second sample speech content feature and the sample emotion feature, to obtain a sample fused feature corresponding to the second speech sample;
performing the animation parameter mapping processing on the sample fused feature, to obtain a predicted controller parameter corresponding to the second speech sample; and
determining a second loss function based on the predicted controller parameter and the real controller parameter, and performing the update processing on the initialized parameter-driven model based on the second loss function, to obtain the trained parameter-driven model.

6. The method according to claim 5, wherein determining the second loss function based on the predicted controller parameter and the real controller parameter comprises:
extracting, from the real controller parameter, a real control parameter corresponding to each animation frame of a plurality of animation frames;
extracting, from the predicted controller parameter, a predicted control parameter corresponding to the each animation frame; and
performing following processing on the each animation frame:
determining a difference between the real control parameter corresponding to the each animation frame and the predicted control parameter corresponding to the each animation frame; and
performing the fusion processing on differences respectively corresponding to the plurality of animation frames, to obtain the second loss function.

7. The method according to claim 1, wherein performing the animation parameter mapping processing on the fused feature, to obtain the controller parameter corresponding to the speech comprises:
performing an attention mechanism-based feed-forward processing on the fused feature, to obtain an animation parameter feature corresponding to the speech; and
performing a fully connected processing on the animation parameter feature, to obtain the controller parameter corresponding to the speech.

8. The method according to claim 7, wherein the attention mechanism-based feed-forward processing is implemented through an attention feed-forward network, and the attention feed-forward network comprises N cascaded feed-forward networks, N being an integer greater than 1; and
wherein performing the attention mechanism-based feed-forward processing on the fused feature, to obtain the animation parameter feature corresponding to the speech comprises:
performing, through an n^{th} feed-forward network among the N cascaded feed-forward networks, an attention mechanism-based mapping processing on an input of the n^{th} feed-forward network, to obtain an n^{th} mapping result, and transmitting the n^{th} mapping result outputted by the n^{th} feed-forward network to an (n+1)^{th} feed-forward network to continue performing the attention mechanism-based mapping processing, to obtain an (n+1)^{th} mapping result corresponding to the (n+1)^{th} feed-forward network; and
using an N^{th} mapping result outputted by an N^{th} feed-forward network as the animation parameter feature corresponding to the speech, wherein
n is an integer variable incrementing from 1, n is not less than 1 and less than N, when n is 1, the input of the n^{th} feed-forward network is the fused feature, and when n is not less than 2 and less than N, the input of the n^{th} feed-forward network is an (n−1)^{th} mapping result outputted by an (n−1)^{th} feed-forward network.

9. The method according to claim 8, wherein when n is not less than 2 and less than N, performing the attention mechanism-based mapping processing on the input of the n^{th} feed-forward network, to obtain the n^{th} mapping result comprises:
performing an attention processing on the (n−1)^{th} mapping result, to obtain an n^{th} attention feature;
performing an addition processing on the (n−1)^{th} mapping result and the n^{th} attention feature, to obtain an n^{th} intermediate feature;
performing a convolution processing on the n^{th} intermediate feature, to obtain an n^{th} convolutional feature; and
performing the addition processing on the n^{th} convolutional feature and the n^{th} intermediate feature, to obtain the n^{th} mapping result.

10. The method according to claim 9, wherein the n^{th} feed-forward network comprises a plurality of attention networks, and performing the attention processing on the (n−1)^{th} mapping result, to obtain the n^{th} attention feature comprises:
obtaining a query matrix, a key matrix, and a value matrix of each attention network;
performing following processing through each attention network:
performing a single-head attention processing on the (n−1)^{th} mapping result based on the query matrix, the key matrix, and the value matrix of the attention network, to obtain a single-head attention result corresponding to the attention network; and
performing the fusion processing on single-head attention results respectively corresponding to the plurality of attention networks, to obtain the n^{th} attention feature.

11. The method according to claim 10, wherein performing the single-head attention processing on the (n−1)^{th} mapping result based on the query matrix, the key matrix, and the value matrix of the attention network, to obtain the single-head attention result corresponding to the attention network comprises:
determining a dot product of the query matrix and the key matrix;
using a ratio between the dot product and a square root of a dimension as a similarity score matrix, wherein the dimension is a dimension of a key vector in the key matrix;
performing a normalization processing on the similarity score matrix, to obtain a normalized matrix; and
performing a matrix multiplication processing on the normalized matrix and the value matrix, to obtain the single-head attention result corresponding to the attention network.

12. An artificial intelligence-based data processing apparatus, comprising a memory for storing instructions and a processor for executing the instructions to:
obtain a speech and emotion data corresponding to the speech;
perform a first speech content feature extraction processing on the speech, to obtain a first speech content feature corresponding to the speech, and perform an emotion feature extraction processing on the emotion data, to obtain an emotion feature corresponding to the speech;
perform a fusion processing on the first speech content feature and the emotion feature, to obtain a fused feature corresponding to the speech; and
perform an animation parameter mapping processing on the fused feature, to obtain a controller parameter corresponding to the speech, the controller parameter being configured for controlling a virtual object model to present in a target image, wherein the target image matches content and the emotion data of the speech.

13. The artificial intelligence-based data processing apparatus according to claim 12, wherein the processor, when being configured to obtain the emotion data corresponding to the speech, is configured to execute the instructions to:
perform any one of following processing:
obtain the emotion data inputted by an object; and
perform a second speech content feature extraction processing on the speech, to obtain a second speech content feature corresponding to the speech, and perform an emotion data mapping processing on the second speech content feature, to obtain the emotion data corresponding to the speech.

14. The artificial intelligence-based data processing apparatus according to claim 13, wherein the processor, when being configured to perform the emotion data mapping processing on the second speech content feature, to obtain the emotion data corresponding to the speech, is configured to execute the instructions to:
perform a fully connected processing on the second speech content feature, to obtain a first linear mapping result; and
perform a maximum likelihood processing on the first linear mapping result, to obtain the emotion data corresponding to the speech.

15. The artificial intelligence-based data processing apparatus according to claim 14, wherein the emotion data is obtained by invoking a trained emotion extraction network; and the processor is further configured to execute the instructions to:
obtain a first speech sample, and obtain an emotion data tag corresponding to the first speech sample;
perform the second speech content feature extraction processing on the first speech sample through an initialized emotion extraction network, to obtain a first sample speech content feature corresponding to the first speech sample;
perform the emotion data mapping processing on the first sample speech content feature through the initialized emotion extraction network, to obtain predicted emotion data corresponding to the first speech sample;
determine a first loss function based on the emotion data tag and the predicted emotion data corresponding to the first speech sample; and
perform an update processing on the initialized emotion extraction network based on the first loss function, to obtain the trained emotion extraction network.

16. The artificial intelligence-based data processing apparatus according to claim 15, wherein the controller parameter is obtained by invoking a trained parameter-driven model; and the processor is further configured to execute the instructions to:
obtain a training sample and a real controller parameter of the training sample, the training sample comprising a second speech sample and an emotion data sample corresponding to the second speech sample; and
perform following processing through an initialized parameter-driven model:
perform the first speech content feature extraction processing on the second speech sample, to obtain a second sample speech content feature corresponding to the second speech sample, and perform the emotion feature extraction processing on the emotion data sample, to obtain a sample emotion feature corresponding to the second speech sample;
perform the fusion processing on the second sample speech content feature and the sample emotion feature, to obtain a sample fused feature corresponding to the second speech sample;
perform the animation parameter mapping processing on the sample fused feature, to obtain a predicted controller parameter corresponding to the second speech sample; and
determine a second loss function based on the predicted controller parameter and the real controller parameter, and perform the update processing on the initialized parameter-driven model based on the second loss function, to obtain the trained parameter-driven model.

17. The artificial intelligence-based data processing apparatus according to claim 16, wherein the processor, when being configured to determine the second loss function based on the predicted controller parameter and the real controller parameter, is configured to execute the instructions to:
extract, from the real controller parameter, a real control parameter corresponding to each animation frame of a plurality of animation frames;
extract, from the predicted controller parameter, a predicted control parameter corresponding to the each animation frame; and
perform following processing on the each animation frame:
determine a difference between the real control parameter corresponding to the each animation frame and the predicted control parameter corresponding to the each animation frame; and
perform the fusion processing on differences respectively corresponding to the plurality of animation frames, to obtain the second loss function.

18. The artificial intelligence-based data processing apparatus according to claim 12, wherein the processor, when being configured to perform the animation parameter mapping processing on the fused feature, to obtain the controller parameter corresponding to the speech, is configured to execute the instructions to:
perform an attention mechanism-based feed-forward processing on the fused feature, to obtain an animation parameter feature corresponding to the speech; and
perform a fully connected processing on the animation parameter feature, to obtain the controller parameter corresponding to the speech.

19. The artificial intelligence-based data processing apparatus according to claim 18, wherein the attention mechanism-based feed-forward processing is implemented through an attention feed-forward network, and the attention feed-forward network comprises N cascaded feed-forward networks, N being an integer greater than 1; and
wherein the processor, when being configured to perform the attention mechanism-based feed-forward processing on the fused feature, to obtain the animation parameter feature corresponding to the speech, is configured to execute the instructions to:
perform, through an n^{th} feed-forward network among the N cascaded feed-forward networks, an attention mechanism-based mapping processing on an input of the n^{th} feed-forward network, to obtain an n^{th} mapping result, and transmit the n^{th} mapping result outputted by the n^{th} feed-forward network to an (n+1)^{th} feed-forward network to continue performing the attention mechanism-based mapping processing, to obtain an (n+1)^{th} mapping result corresponding to the (n+1)^{th} feed-forward network; and
use an N^{th} mapping result outputted by an N^{th} feed-forward network as the animation parameter feature corresponding to the speech, wherein
n is an integer variable incrementing from 1, n is not less than 1 and less than N, when n is 1, the input of the n^{th} feed-forward network is the fused feature, and when n is not less than 2 and less than N, the input of the n^{th} feed-forward network is an (n−1)^{th} mapping result outputted by an (n−1)^{th} feed-forward network.

20. A non-transitory computer readable medium storing a plurality of instructions, wherein the plurality of instructions, when executed by a processor, configure the instructions to:
obtain a speech and emotion data corresponding to the speech;
perform a first speech content feature extraction processing on the speech, to obtain a first speech content feature corresponding to the speech, and perform an emotion feature extraction processing on the emotion data, to obtain an emotion feature corresponding to the speech;
perform a fusion processing on the first speech content feature and the emotion feature, to obtain a fused feature corresponding to the speech; and
perform an animation parameter mapping processing on the fused feature, to obtain a controller parameter corresponding to the speech, the controller parameter being configured for controlling a virtual object model to present in a target image, wherein the target image matches content and the emotion data of the speech.
